(19) United States
(12) Patent Application Publication
(10) Pub. No.: US 2014/0305310 A1
(43) Pub. Date: Oct. 16, 2014

(54) PROTEIN DEBUBBLER IMPELLER STRUCTURE

(71) Applicants: Shao Chi Chien, New Taipei City (TW); Chih Wei Chen, New Taipei City (TW)

(72) Inventors: Shao Chi Chien, New Taipei City (TW); Chih Wei Chen, New Taipei City (TW)

(21) Appl. No.: 14/248,336

(22) Filed: Apr. 9, 2014

(30) Foreign Application Priority Data
Apr. 10, 2013 (TW) 102206542

(51) Int. Cl. B01D 19/00

(52) U.S. Cl. CPC B01D 19/0052
USPC 96/178

(57) ABSTRACT

An improvement of protein debubbler impeller structure includes an impeller pivotally installed at a bottom of the protein debubbler to be driven by an impact from a polluted water and ambient air under pressure introduced through an intake port along a radial direction to generate an upward vortex and multiply bubbles. The bubbles pass through an orifice of a press pad positioned above after absorb the pollution substances to generate more fine bubbles for carrying more pollution substances in the water. Then the fine bubbles overflow into a collector and dissipate that the pollution substances are collected. The rotation of the impeller generating vortex can not only increase the amount of bubbles generated but also enhance the mixing of bubbles with the polluted water for improving the cleaning effectiveness.

### (a) TECHNICAL FIELD OF THE INVENTION

The present invention is related to an improvement of protein debubbler impeller structure, particularly a protein debubbler with an impeller positioned at bottom such that a water and air entering from an intake port can drive the impeller to rotate and generate an upward vortex water flow within the protein debubbler.

### (b) DESCRIPTION OF THE PRIOR ART

Aquarium enthusiasts and users usually use filtration systems to circulate the water in their aquarium tanks for maintaining them clean. However the filters of the filtration systems have a service period so limited that the users must either clean the filters or replace with new ones within a short period of time. Therefore the filtration systems of the prior art become a financial burden to the aquarium enthusiasts and users.

Recently a vendor offers a protein debubbler utilizing the surface tension of an air bubble to absorb protein and other pollution substances in water. The protein debubbler of the prior art includes an outer casing within which a taper pipe is provided. The water in an aquarium tank and ambient air are pressurized by a pump for entering a bottom of the outer casing so as to generate bubbles. The bubbles rise upward along the taper pipe into a collecting tank and then dissipate such that the pollution substances carrier by the rising bubbles are collected inside the collecting tank for disposal. The water in the outer casing can be circulated back to the aquarium tank after cleaning so as to constitute a water circulation system. However, when the water of the aquarium tank and ambient air are pumped into the bottom of the outer casing the compression is released and thus the bubbles inside the water in the outer casing can only rise slowly upward by buoyancy. Consequently the bubbles cannot become finer bubbles clusters to be mixed with the water for adequate cleaning. Therefore there is a demand to improve the protein debubbler of the prior art in terms of effectiveness on cleaning water.

### SUMMARY OF THE INVENTION

An objective of the present invention is to provide an improvement of protein debubbler impeller structure by an impeller pivotally installed at a bottom of the protein debubbler that the polluted water and ambient air under pressure introduced through an intake port will impact the impeller along its radial direction and thus drive the impeller rotating. The rotation of the impeller will generate an upward vortex in the polluted water in the protein debubbler with multiply bubbles to absorb the pollution substances in the polluted water. The bubbles then pass through a orifice with taper internal diameter of a press pad to generate more fine bubbles that can easily absorb and carry more protein and other pollution substances into a collector and then dissipate for collecting the pollution substances. The rotation of the impeller disturbing the polluted water can not only increase the bubbles generation but also achieve adequate mixing of bubbles and polluted water for enhancing the cleaning effectiveness of the protein debubbler.

The improvement of protein debubbler impeller structure includes an outer casing vertically positioned on a base, an impeller pivotally installed on the base as positioned at a bottom of the outer casing, an intake port positioned at the outer casing and aligned to a vane of the impeller along its radial direction, an outlet port fluid dynamically connect with the bottom of the outer casing and provided with a valve to control a discharge flow rate for discharging a clean water after cleaning, a press pad inserted in the outer casing and provided with multiply orifices while each of them is provided with an internal diameter tapered upward, and a collector overlapped on a top of the outer casing and provided with both a neck-pipe, which has a bottom end positioned at a gap from the press pad, at an axial direction at a bottom of the collector and a drainage for draining a polluted water. Thereby, when the polluted water and ambient air are pressurized to be introduced through the intake port, the water flow will impact the impeller to rotate at high speed and each vane of the impeller will disturb the polluted water containing ambient air in the outer casing to generate multiply bubbles and an upward vortex. The bubbles will rise upward along the wall of the outer casing and absorb the protein and other pollution substances on the way and be further compressed when passing through the orifices of the press pad to generate more fine bubbles that can easily absorb and carry the protein and other pollution substances moving upward. The bubbles will be pushed upward to the neck-pipe and dissipate in the collector after overflow out of the neck-pipe. Therefore the protein and other pollution substances are collected in the collector ready to be drained out through the drainage.

In the improvement of protein debubbler impeller structure, a top end of the valve is secured to a thread portion of an adjusting bar pivotally installed on a bracket. Thus a user can turn the adjusting bar to raise or lower the valve in order to control the flow rate through the outlet port as well as to adjust the water level inside the protein debubbler of the present invention.

### BRIEF DESCRIPTION OF THE DRAWINGS

FIG. 1 is a perspective diagram illustrating the present invention.

FIG. 2 is a cross-sectional diagram illustrating the structure of a preferred embodiment of the present invention.

FIG. 3 is a perspective diagram illustrating an impeller of the preferred embodiment of the present invention.

FIG. 4 is a cross-sectional diagram along 4-4 cut-off line of FIG. 2 illustrating the preferred embodiment of the present invention.

### DETAILED DESCRIPTION OF THE PREFERRED EMBODIMENTS

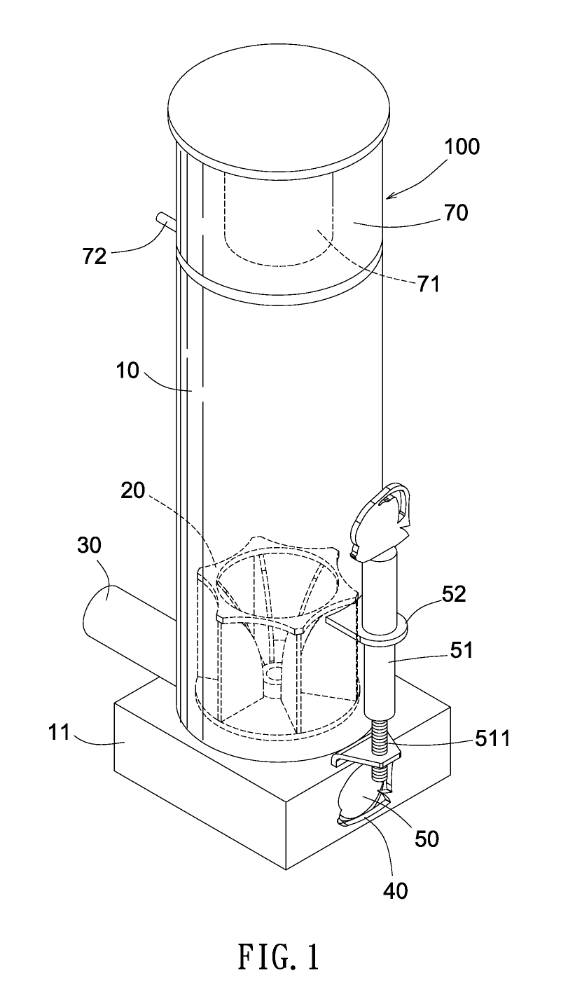

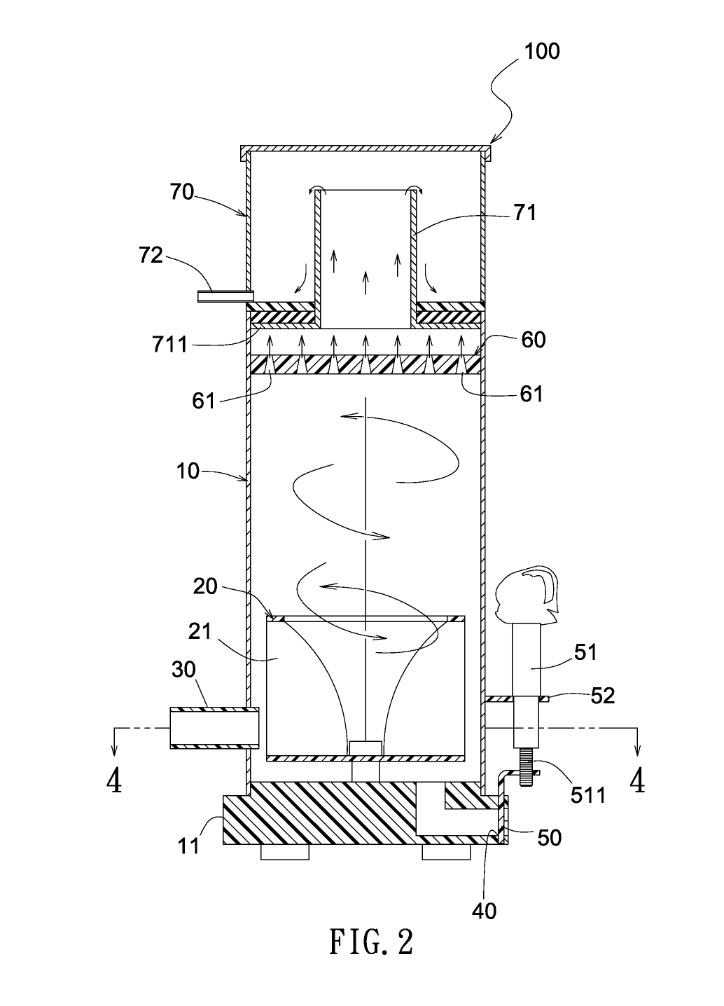

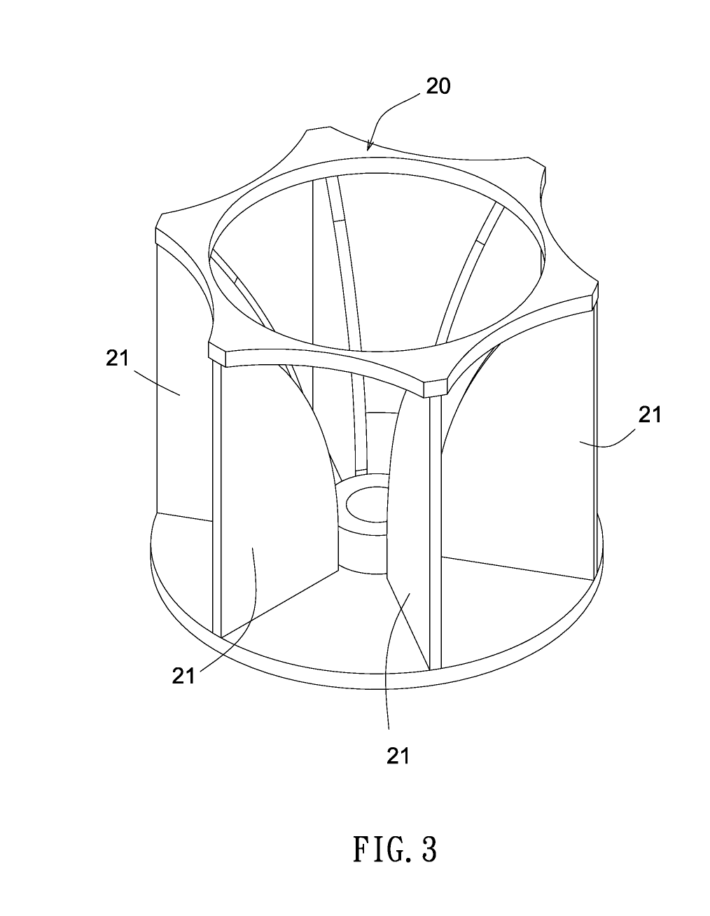

Please refer FIG. 1 to FIG. 4 illustrating a preferred embodiment of the present invention related an improvement of protein debubbler impeller structure. The protein debubbler 100 has a base on which an impeller 20 is pivotally installed to be driven by an impact from a polluted water and ambient air under pressure through an intake port 30 along a radial direction with respect to the impeller 20 so as to generate an upward vortex and multiply bubbles from a rotation of the impeller 20 within the water in the protein debubbler 100 as indicated by an arrow mark in FIG. 2. The bubbles are driven by the upward water flow to pass through an orifice 61 of a press pad 60 as positioned above so as to generate relatively more fine bubbles for carrying more pollution substances in the water. Then the fine bubbles overflow into a collector 70 and dissipate that the pollution substances carried by the fine bubbles are collected to be disposed. The rotation of the impeller 20 generating vortex can not only increase the amount of bubbles generated but also enhance the mixing of bubbles with the water for improving the cleaning effectiveness.

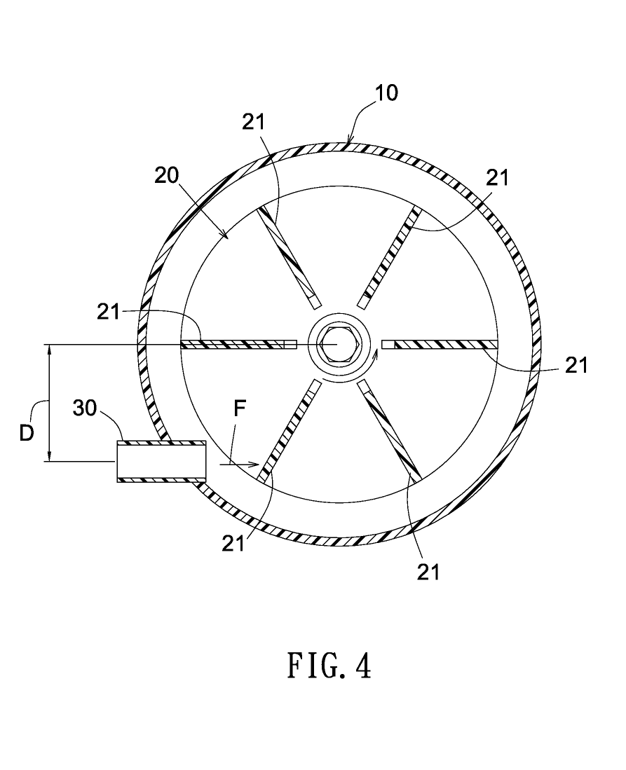

As shown in FIGS. 1 and 2, a preferred embodiment of an improvement of protein debubbler impeller structure disclosed by the present invention includes an outer casing 10, which is vertically positioned on a base 11, an impeller 20, which is pivotally installed on the base 11 as positioned at a bottom of the outer casing 10, an intake port 30, which is positioned at the outer casing 10 and aligned to a vane 21 of the impeller 20 along its radial direction with a centerline offset a clearance D with respect to a centerline of the impeller 20, on a different from that of the impeller 20, as shown in FIG. 4, an outlet port 40, which is fluid dynamically connect with a bottom of the outer casing 10 and provided with a valve 50 to control a discharge flow rate for discharging a clean water after cleaning, a press pad 60, which is inserted in the outer casing 10 and provided with multiply orifices 61 while each of them is provided with an internal diameter tapered upward, and a collector 70, which is overlapped on a top of the outer casing 10 and provided with a neck-pipe 71 at an axial direction at a bottom of the collector 70 and a drainage 72 for draining a polluted water while a bottom end of the neck-pipe 71 is positioned at a gap from the press pad 60. As shown in FIGS. 2 and 4, when the polluted water and ambient air are pressurized to be introduced through the intake port 30, the water flow F will impact the impeller 20 that will rotate at high speed. Then each vane 21 of the impeller 20 will disturb the polluted water containing ambient air in the outer casing 10 so as to generate multiply bubbles and a vortex flowing upward. The bubbles will rise upward along the wall of the outer casing 10 and absorb the protein and other pollution substances on the way. The bubbles will be further compressed when passing through the orifices 61 of the press pad 60 so as to generate more fine bubbles that can easily absorb and carry the protein and other pollution substances moving upward. The bubbles will reach the neck-pipe 71 of the collector 70 and thus be pushed upward until overflow out of the neck-pipe 71 and then dissipate in the collector 70. Therefore the protein and other pollution substances are collected in the collector 70 ready to be drained out through the drainage 71.

In the improvement of protein debubbler impeller structure, a top end of the valve 50 is secured to a thread portion 511 of an adjusting bar 51, which is pivotally installed on a bracket 52. Thus a user can turn the adjusting bar 51 to raise or lower the valve 50 in order to control the flow rate through the outlet port 40 as well as to adjust the water level inside the protein debubbler 100 of the preferred embodiment.

The intake port 30 of the improvement of protein debubbler impeller structure is connected to an outlet of a pressure pump, which is used to extract the polluted water in an aquarium tank. The outlet port 40 of the improvement of protein debubbler impeller structure is connected to the aquarium tank or a storage and then return to the aquarium tank via another pump. However the present invention does not limit the application.

In summary the improvement of protein debubbler impeller structure has following advantages:
1. Adequate mixing of bubbles and polluted water is achieved by the impeller 20 disturbing the polluted water for enhancing the effectiveness of bubbles absorbing pollution substance.
2. Fast rotation of the impeller 20 can generate significant amount of bubbles inside the protein debubbler 100 for enhancing the effectiveness of cleaning.
3. The impeller 20 of the present invention is driven to rotate by the polluted water introduced without the need of additional electricity for reducing the energy consumption.

I claim:

1. An improvement of protein debubbler impeller structure comprising
an outer casing, vertically positioned on a base;
an impeller, pivotally installed on the base and positioned at a bottom of said outer casing;
an intake port, positioned at said outer casing and aligned to a vane of said impeller along its radial direction with a centerline offset a clearance with respect to a centerline of said impeller;
an outlet port, fluid dynamically connected with the bottom of said outer casing and provided with a valve to control a discharge flow rate for discharging a clean water after cleaning;
a press pad, inserted in said outer casing and provided with multiply orifices and each of the multiply orifices provided with an internal diameter tapered upward; and
a collector, overlapped on a top of said outer casing and provided with a neck-pipe at an axial direction at a bottom of said collector and a drainage for draining a polluted water.

2. The improvement of protein debubbler impeller structure of claim 1 wherein a top end of the valve is secured to a thread portion of an adjusting bar that is pivotally installed on a bracket.

3. The improvement of protein debubbler impeller structure of claim 1 wherein a bottom end of the neck-pipe is positioned at a gap from said press pad.
